(19) United States
(12) Patent Application Publication
(10) Pub. No.: US 2025/0377533 A1
(43) Pub. Date: Dec. 11, 2025

(54) Adjustable Weight and Bore Size Counterweight for a Telescope Mount

(71) Applicant: Brian Clements, Holland, PA (US)

(72) Inventor: Brian Clements, Holland, PA (US)

(21) Appl. No.: 18/737,290

(22) Filed: Jun. 7, 2024

(51) Int. Cl. G02B 23/16

(52) U.S. Cl. CPC G02B 23/165

(57) ABSTRACT

An improved astronomy counterweight featuring an adjustable weight and adjustable bore hole diameter is disclosed which includes an inner adapter, a main body weight, a bottom lid plate, a locking bolt, and attachment bolts which connect the components through bolt holes. The inner adapter can be swapped with one of a different bore hole diameter, allowing attachment to telescope mounts with varied shaft diameters. The invention can be configured to include or exclude components varying weight. In one embodiment, there are additional weight plates which may be utilized to adjust the weight of the counterweight.

### BACKGROUND OF THE INVENTION

An astronomy counterweight is a weight that you put on a telescope mount to counterbalance the weight of the telescope that sits on top of the mount. Counterweights contain a bore hole through which a shaft of a telescope mount is placed during mounting of the counterweight. Currently, shaft and bore hole diameters are not standardized throughout the market, often requiring individuals to obtain a new counterweight with a complementary bore hole diameter for each telescope mount. Also, current counterweights are offered in varying fixed weights, requiring individuals with multiple telescopes to obtain multiple counterweights to match the weight required to counterbalance each telescope they wish to mount.

### SUMMARY OF THE INVENTION

What is presented is an improved astronomy counterweight featuring an adjustable weight and adjustable bore hole diameter. This Summary is provided to introduce a selection of concepts in a simplified form that is further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

In at least one embodiment of the invention, there exists an inner adapter 4, a main body weight 7, a bottom lid plate 2, a locking bolt 6, and one or more attachment bolts 1. The main body weight 7 has a slot 16 allowing for the insertion of the inner adapter 4. The main body weight 7 and bottom lid plate 2 have aligning vertical attachment bolt holes 24,25, allowing the coupling of the bottom lid plate 2 and main body weight 7 with attachment bolts 1. The main body weight 7 and inner adapter 4 both have a horizontal locking bolt hole 17, through which the locking bolt 6 is inserted. The inner adapter 4 has a central body 13, through which a central bore hole 12 passes, and one or more arms 14. The main body weight 7 and bottom lid plate 2 each have a shaft hole 19,20. The invention is attached to a telescope mount by passing the telescope mount shaft 11 through the central bore hole 12 of the inner adapter and tightening the locking bolt 6 locking bolt holes 17,18 applying pressure to the telescope mount shaft 11.

In at least one embodiment, the inner adapter 4 and main body weight 7 each further comprise one or more aligned horizontal attachment bolt holes 21,22 allowing for coupling of the inner adapter 4 and main body weight 7 via attachment bolts 1.

In at least one embodiment, the inner adapter 4 further comprises one or more vertical attachment bolt holes 9 which align with vertical attachment bolt holes 24 of the main body weight 7 and bottom lid plate 2, allowing the coupling of these pieces utilizing attachment bolts.

In at least one embodiment, the inner adapter 4 and main body weight 7 each further comprise one or more aligned horizontal attachment bolt holes 21,22 allowing for coupling of the inner adapter 4 and main body weight 7 via attachment bolts, and the inner adapter 4 further comprises one or more vertical attachment bolt holes 9 which align with vertical attachment bolt holes 24 of the main body weight 7 and bottom lid plate 2, allowing the coupling of these pieces utilizing attachment bolts.

In at least one embodiment, the inner adapter 4 further comprises one or more threaded horizontal accessory holes 10.

In at least one embodiment, the invention further comprises one or more weight plates 3, which have a central shaft hole 19 with diameter greater than the central bore hole 12 of the inner adapter 4 and one or more vertical attachment bolt holes 23, where the vertical attachment bolt holes 23 align with the vertical attachment bolt holes 24,25 of the main body weight 7 and bottom lid plate 2 to allow coupling of the inner adapter 4, main body weight 7 and bottom lid plate 2 via one or more attachment bolts 1.

In at least one embodiment, the bottom lid plate 2 further comprises a slot 15 shaped to allow insertion of the inner adapter 4.

Those skilled in the art will realize that this invention is capable of embodiments that are different from those shown and that details of the apparatus and methods can be changed in various manners without departing from the scope of this invention. Accordingly, the drawings and descriptions are to be regarded as including such equivalent embodiments as do not depart from the spirit and scope of this invention.

### BRIEF DESCRIPTION OF THE DRAWINGS

A better understanding of the features and advantages of the present invention will be obtained by reference to the following detailed description that sets forth illustrative embodiments, in which the principles of the invention are utilized, and the accompanying drawings of which:

FIG. 1 depicts an exploded view of one embodiment of the claimed invention, identifying various components;

FIG. 2 depicts a prior art telescope demonstrating placement of a telescope counterweight on the shaft of a telescope mount;

FIG. 3 depicts the inner adapter of the embodiment shown in FIG. 1 comprising a cylindrical central body, four rectangular arms, each arm having two vertical attachment bolt holes and one horizontal accessory hole;

FIG. 4 depicts one configuration of the invention where a weight plate is attached and where the main body weight is not attached allowing access to the accessory holes on the inner adapter and identifies components of the inner adapter: the central body, the central bore hole, and an arm;

FIG. 5 depicts an exploded view of one configuration of the invention where a weight plate is attached and where the main body weight is not attached allowing access to the accessory holes on the inner adapter;

FIG. 6 depicts an angled perspective exploded view of one configuration of the invention where a weight plate is attached, where the bottom lid plate is not attached, and where the main body weight is not attached allowing access to the accessory holes on the inner adapter;

FIG. 7 depicts a side perspective exploded view of one configuration of the invention where a weight plate is attached, where the bottom lid plate is not attached, and where the main body weight is not attached allowing access to the accessory holes on the inner adapter;

FIG. 8 depicts a side perspective exploded view of one configuration of the invention where a weight plate and bottom lid plate are attached and where the main body weight is not attached allowing access to the accessory holes on the inner adapter;

FIG. 9 depicts an exploded view of an embodiment of the invention where the bottom lid plate comprises a slot shaped for the insertion of the inner adapter;

FIG. 10 depicts an exploded view of an embodiment of the invention where the inner adapter has one arm;

FIG. 11 depicts a non-exploded view of an embodiment of the invention with no weight plate;

FIG. 12A depicts a non-exploded angled view of the top of an embodiment of the invention with no weight plate;

FIG. 12B depicts a non-exploded angled view of the top of an embodiment of the invention with a weight plate;

FIG. 13A depicts a non-exploded angled view of the bottom of an embodiment of the invention with no weight plate;

FIG. 13B depicts a non-exploded angled view of the top of an embodiment of the invention with a weight plate;

FIG. 14A depicts a top view of the main body weight and identifies the slot into which the inner adapter sits;

FIG. 14B depicts an inner adapter with complementary shape to the slot in the main body weight depicted in FIG. 14A;

FIG. 15 depicts multiple embodiments of the inner adapter with varied central bore hole diameter;

FIG. 16A depicts an exploded view of a configuration of the invention without a weight plate;

FIG. 16B depicts an exploded view of a configuration of the invention with a weight plate;

FIG. 17A depicts an angled perspective view of the weight plate;

FIG. 17B depicts an angled perspective view of the weight plate;

FIG. 18 depicts multiple configurations of the invention to obtain varied weights;

FIG. 19A depicts an angled perspective view of the main body weight;

FIG. 19B depicts an angled perspective view of the main body weight;

FIG. 20A depicts an angled perspective view of the bottom lid plate;

FIG. 20B depicts an angled perspective view of the bottom lid plate; and

FIG. 21A, FIG. 21B, and FIG. 21C depict multiple angles of one embodiment of the inner adapter, with cylindrical arms and central body.

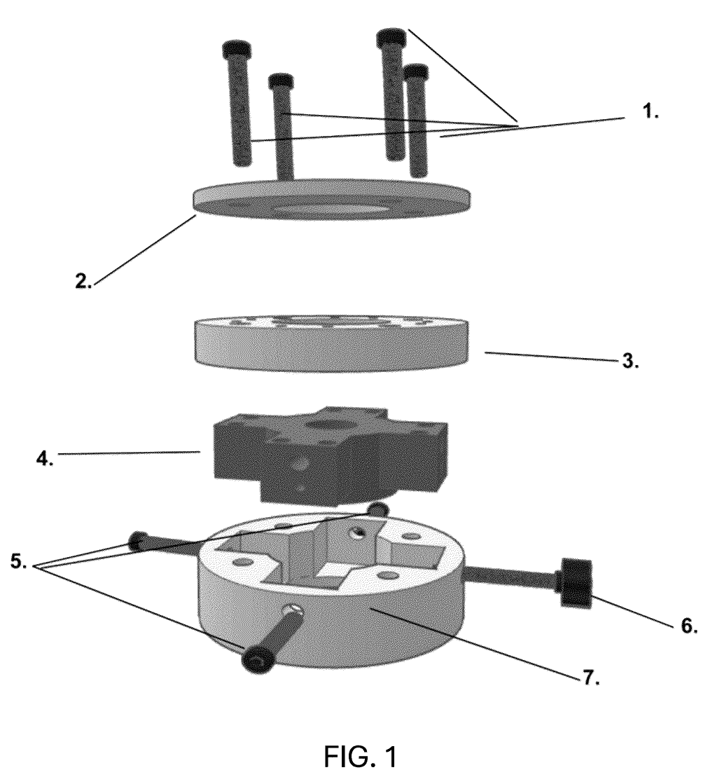

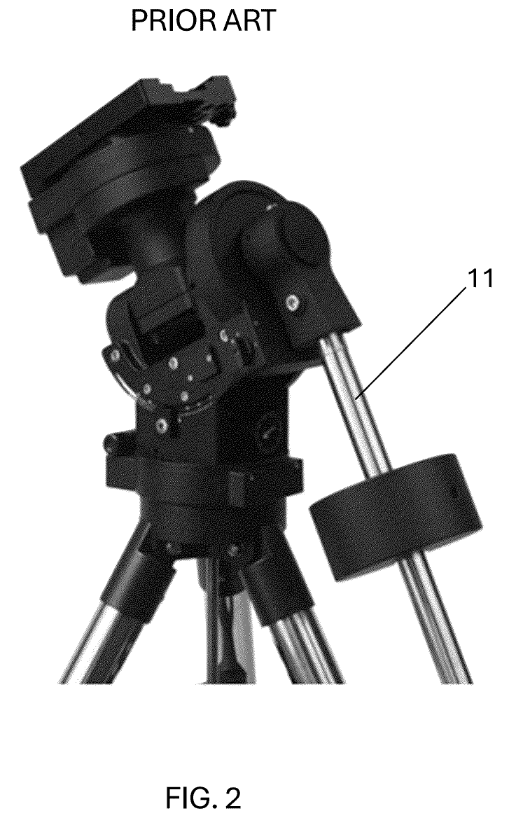

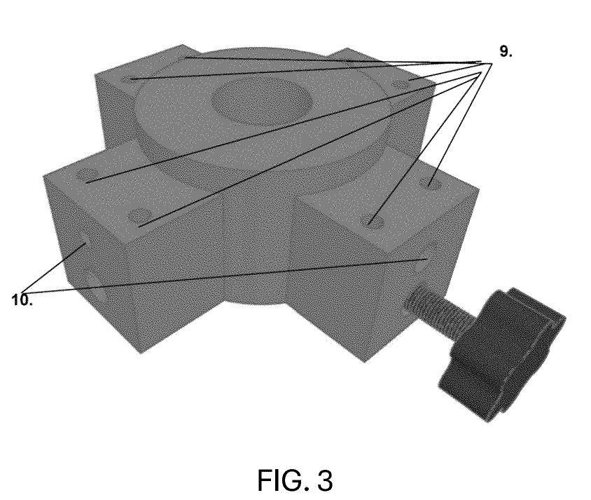

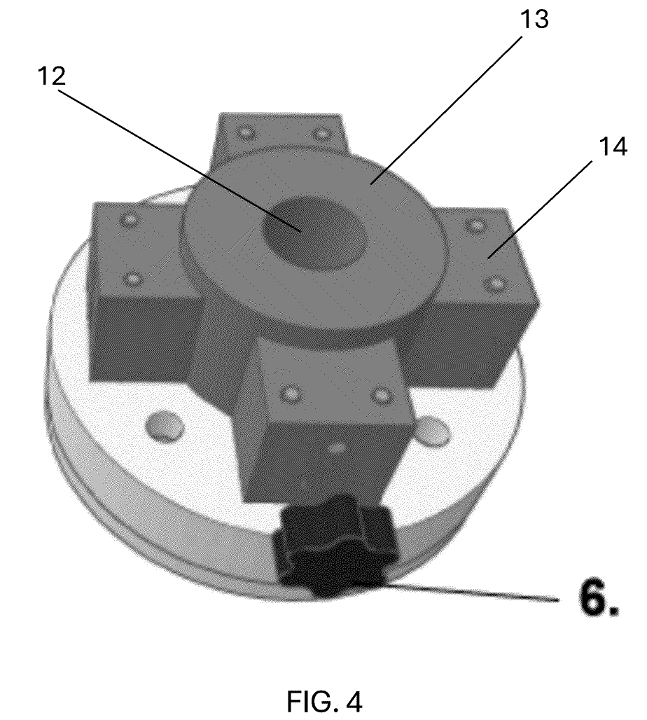

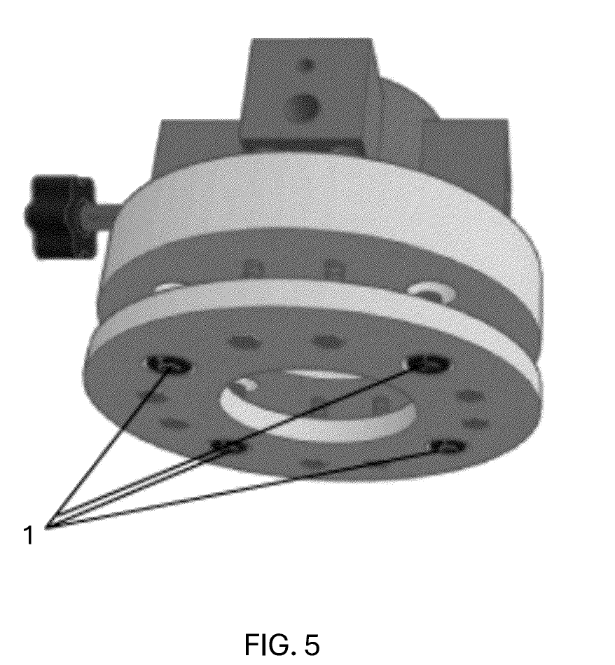

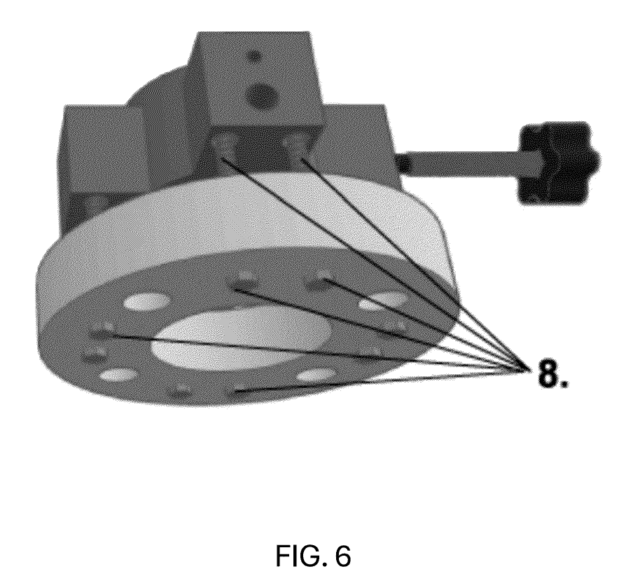

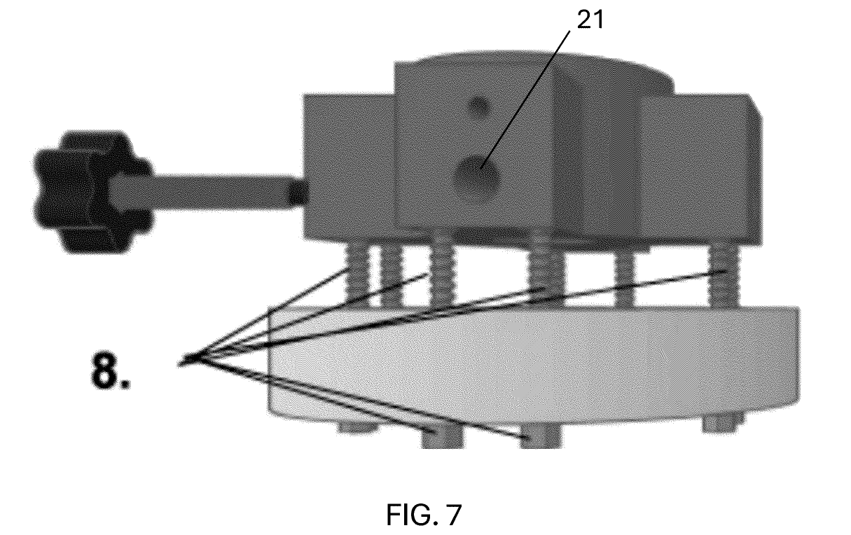

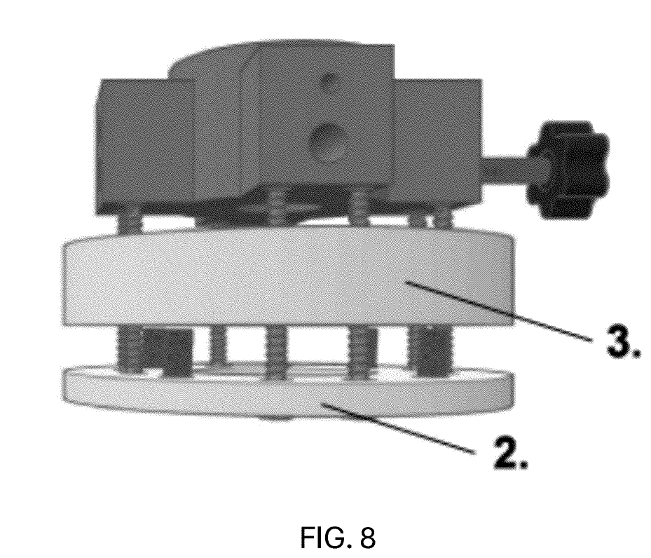

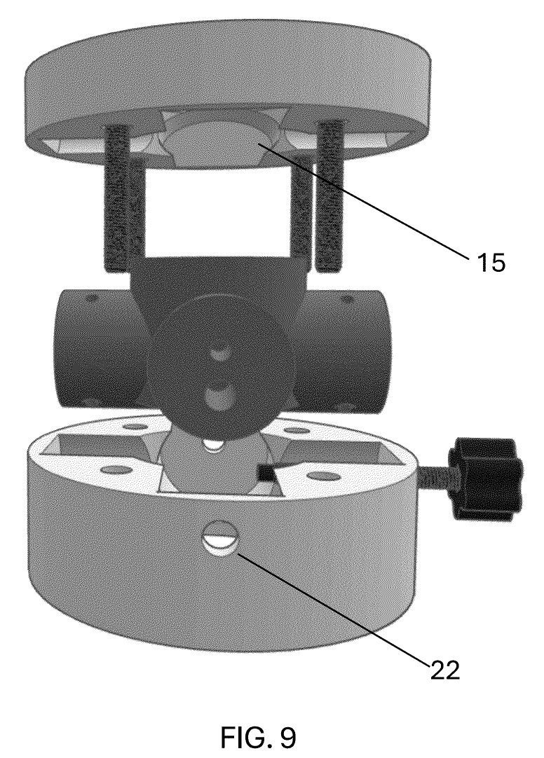

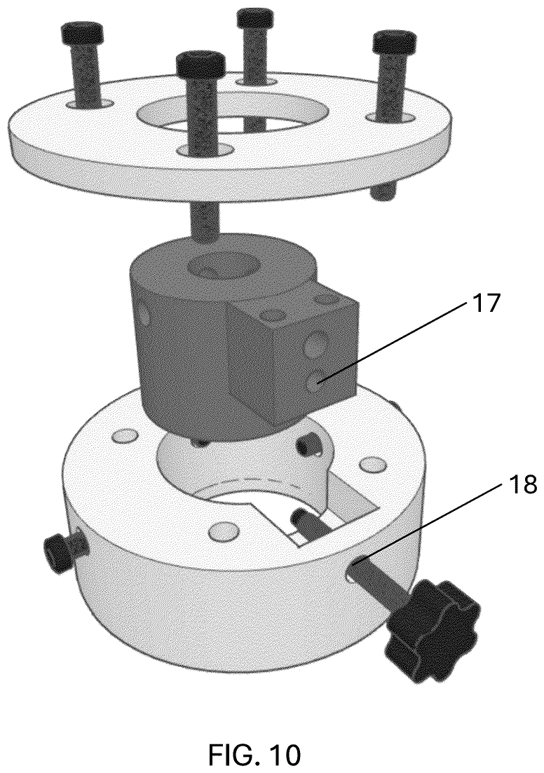

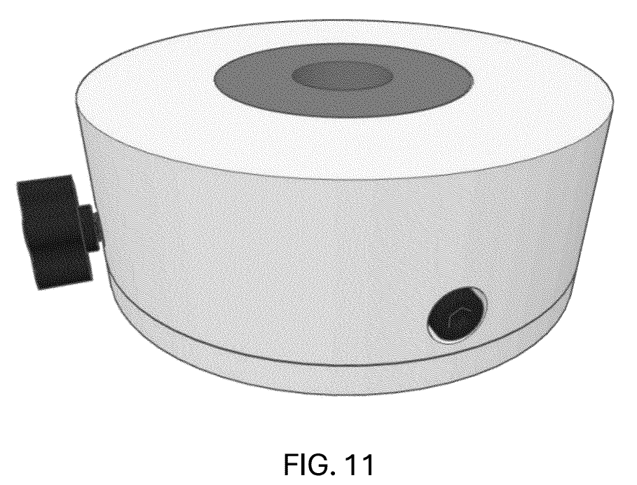

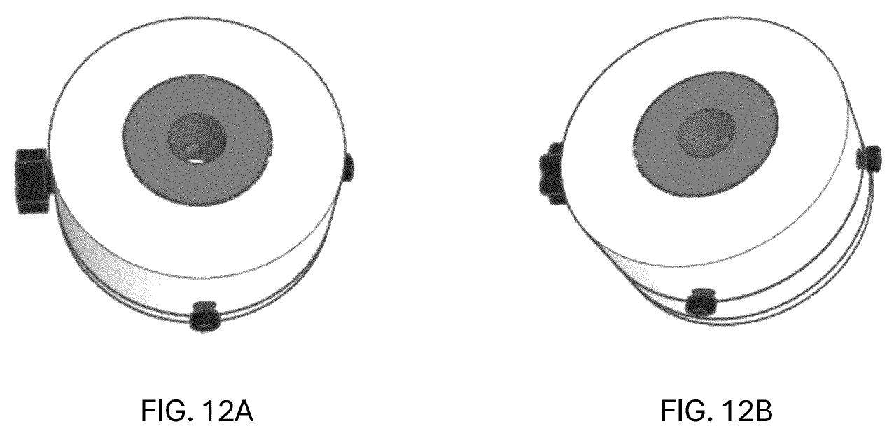

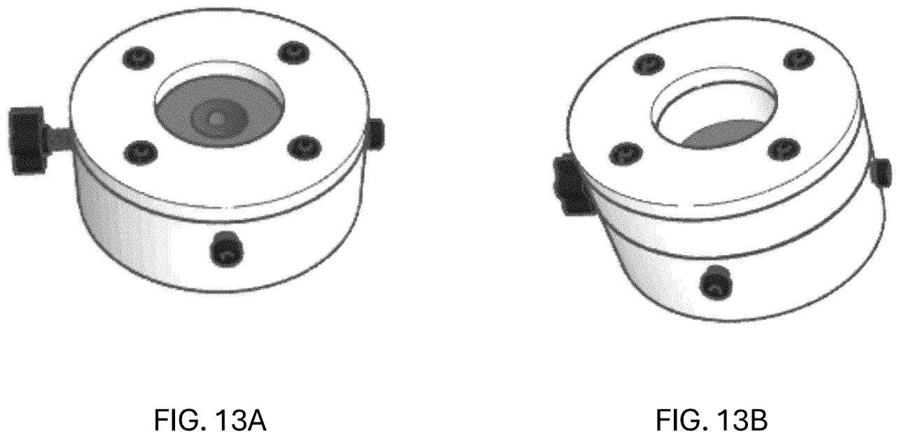

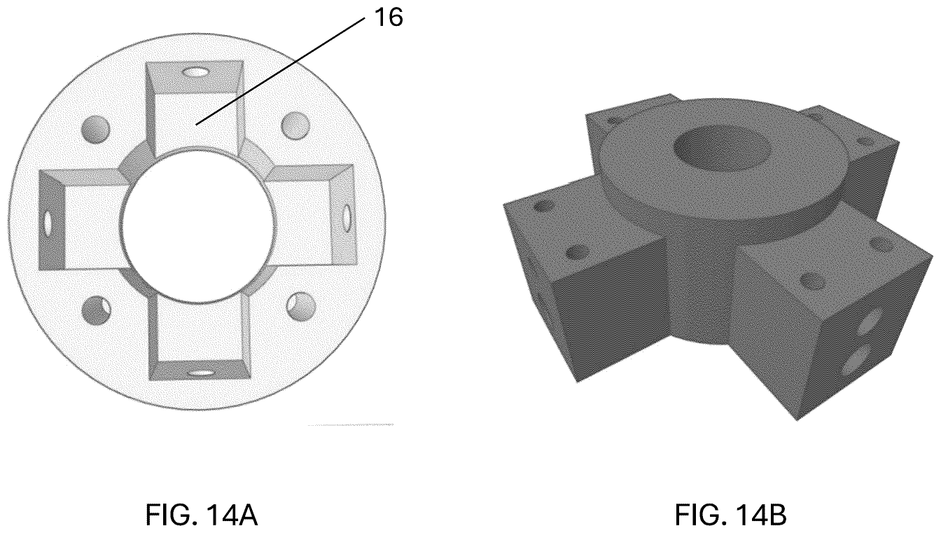

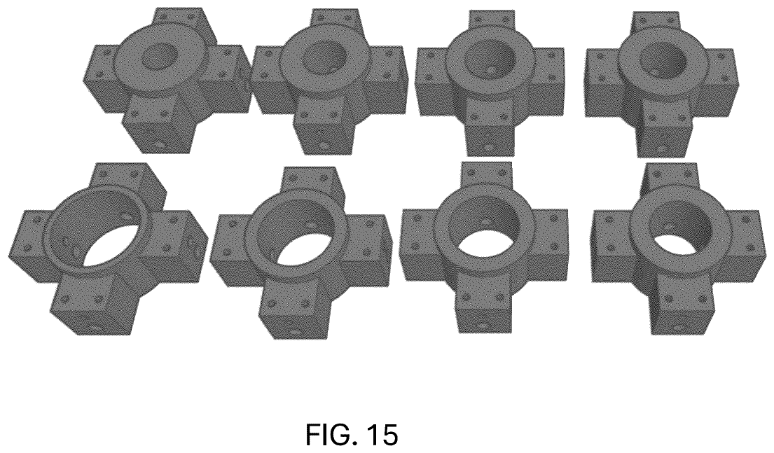

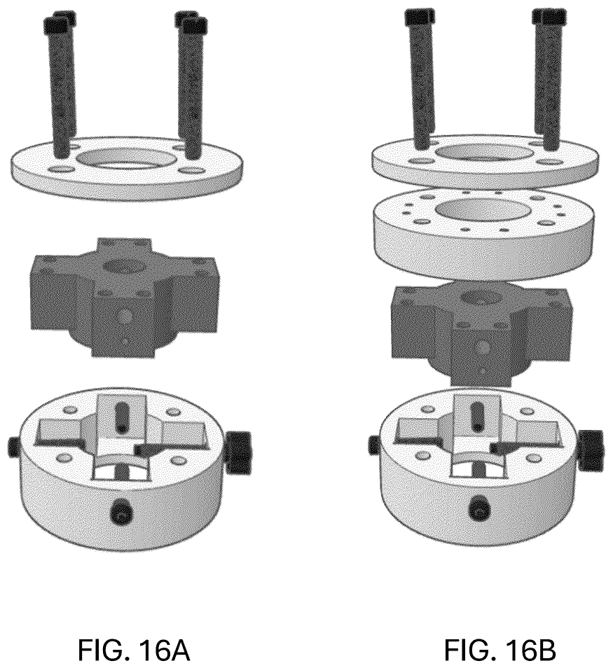

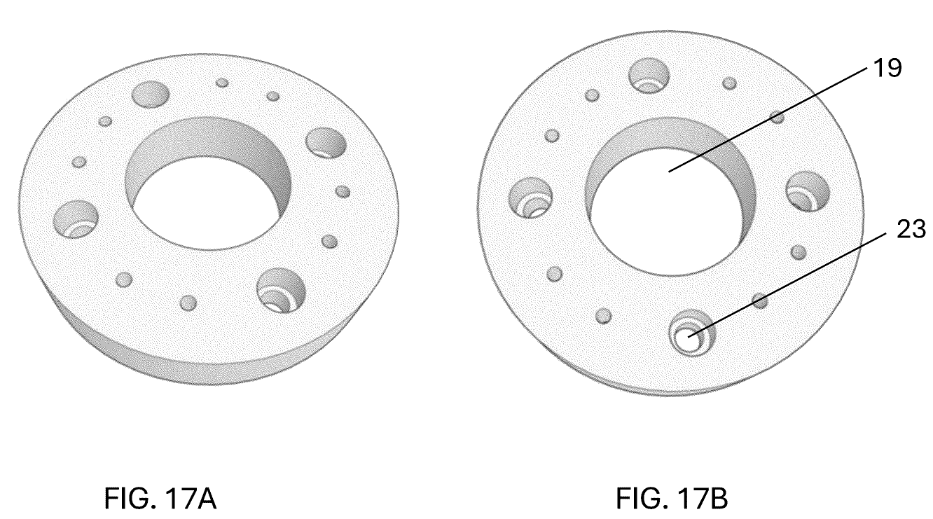

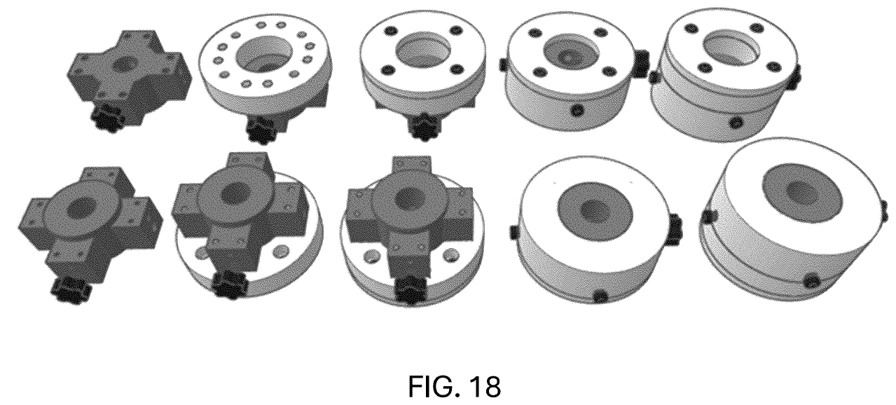

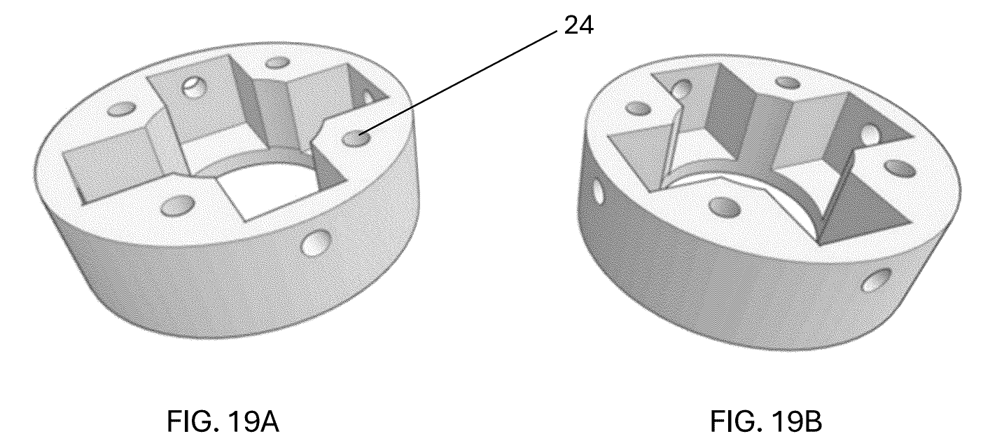

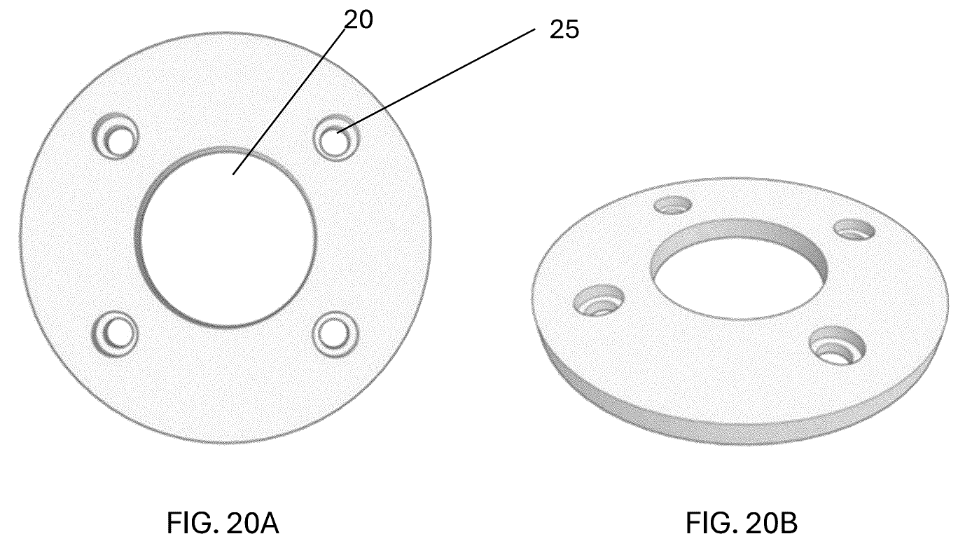

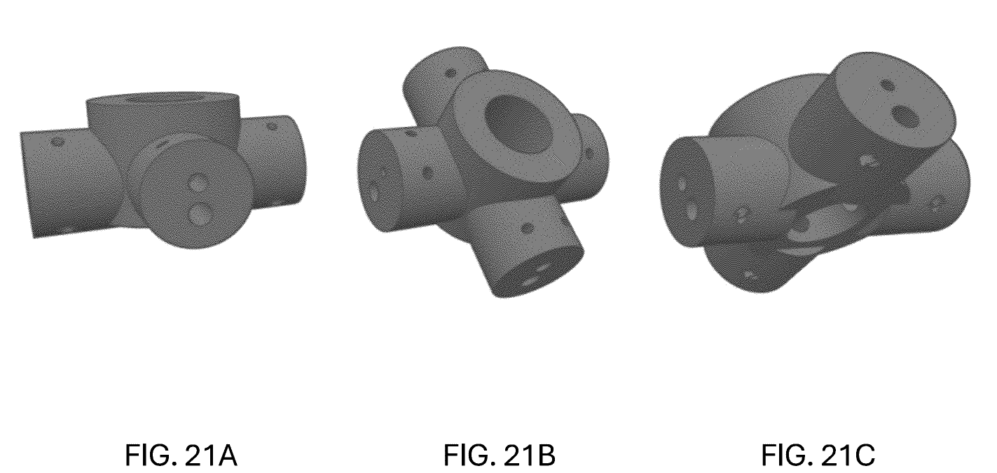

### DETAILED DESCRIPTION OF THE INVENTION

Referring to the drawings, some of the reference numerals are used to designate the same or corresponding parts through several of the embodiments and figures shown and described. Corresponding parts are denoted in different embodiments with the addition of lowercase letters. Variations of corresponding parts in form or function that are depicted in the figures are described. It will be understood that variations in the embodiments can generally be interchanged without deviating from the invention.

In one embodiment of the invention, there exists an inner adapter 4, a main body weight 7, a bottom lid plate 2, a locking bolt 6, and one or more attachment bolts 1. The main body weight 7 has a slot 16 allowing for the insertion of the inner adapter 4. The main body weight 7 and bottom lid plate 2 have vertical attachment holes 9, allowing the coupling of the bottom lid plate 2 and main body weight 7 with attachment bolts 1. The main body weight 7 and inner adapter 4 both have a horizontal locking bolt hole 17, through which the locking bolt 6 is inserted.

The diameter of the central bore hole 12 of the inner adapter can be manufactured to be of whatever size is required for mounting to the shaft 11 of a telescope mount. The inner adapter 4 is removable and replaceable, allowing the user to swap between inner adapters 4 of different diameters required for the variable shaft 11 diameters of multiple telescope mounts.

The locking bolt 6 travels through the main body weight locking bolt hole 18 and inner adapter locking bolt hole 17 where it applies pressure to the shaft 11 of the telescope mount, holding the invention in place.

The invention is capable of multiple configurations, which result in different weights, based on the user's choice whether to attach the main body weight 7 or bottom lid plate 2 to the inner adapter 4 before securing the inner adapter 4 to the shaft 11 of a telescope mount.

In at least one embodiment of the invention, one or more additional weight plates 3b can be included to allow for a greater number of configurations of the invention resulting in a greater range and specificity of weight attached to the shaft of the telescope mount.

The inner adapter 4 has a central body 13, through which a central bore hole 12 passes, and one or more arms 14. The main body weight 7 and bottom lid plate 2 each have a shaft hole 19,20. The invention is attached to a telescope mount by passing the telescope mount shaft 11 through the central bore hole 12 of the inner adapter and tightening the locking bolt 6 locking bolt holes 17,18 applying pressure to the telescope mount shaft 11.

In at least one embodiment, the inner adapter 4 and main body weight 7 each further comprise one or more aligned horizontal attachment bolt holes 21,22 allowing for coupling of the inner adapter 4 and main body weight 7 via attachment bolts 1.

In at least one embodiment, the inner adapter 4 further comprises one or more vertical attachment bolt holes 9 which align with vertical attachment bolt holes 24 of the main body weight 7 and bottom lid plate 2, allowing the coupling of these pieces utilizing attachment bolts.

In at least one embodiment, the inner adapter 4 and main body weight 7 each further comprise one or more aligned horizontal attachment bolt holes 21,22 allowing for coupling of the inner adapter 4 and main body weight 7 via attachment bolts, and the inner adapter 4 further comprises one or more vertical attachment bolt holes 9 which align with vertical attachment bolt holes 24 of the main body weight 7 and bottom lid plate 2, allowing the coupling of these pieces utilizing attachment bolts.

In at least one embodiment, the inner adapter 4 further comprises one or more threaded horizontal accessory holes 10, which allows for the attachment of other astronomy equipment to the invention.

In at least one embodiment, the invention further comprises one or more weight plates 3b, which have a central shaft hole 19b with diameter greater than the central bore hole 12 of the inner adapter 4 and one or more vertical attachment bolt holes 23b, where the vertical attachment bolt holes 23b align with the vertical attachment bolt holes 24,25 of the main body weight 7 and bottom lid plate 2 to allow coupling of the inner adapter 4, main body weight 7 and bottom lid plate 2 via one or more attachment bolts 1. The weight plates may be stacked in between the main body plate 7 and the bottom lid plate 2, allowing a greater maximum weight and increased weight specificity in configuring the invention before attaching to the telescope mount.

In at least one embodiment, the bottom lid plate 2c further comprises a slot 15c shaped to allow insertion of the inner adapter 4c. This increases the weight and size of the bottom lid plate 2c and decreases the weight and size of the main body weight 7c.

This invention has been described with reference to several preferred embodiments. Many modifications and alterations will occur to others upon reading and understanding the preceding specification. It is intended that the invention be construed as including all such alterations and modifications in so far as they come within the scope of the appended claims or the equivalents of these claims.

What is claimed is:

1. A counterweight for a telescope mount, wherein the telescope mount contains a shaft, comprising:
an inner adapter;
a main body weight;
a bottom lid plate;
a locking bolt; and
one or more attachment bolts;
wherein said inner adapter comprises a central body, at least one arm, a vertical central bore hole, and a horizontal locking bolt hole for receiving said one or more locking bolt;
wherein said main body weight comprises a central shaft hole, a locking bolt hole for receiving said locking bolt, one or more vertical attachment bolt holes for receiving said one or more attachment bolts, and a slot shaped to allow insertion of the inner adapter;
wherein said bottom lid plate comprises a central shaft hole and one or more vertical attachment bolt holes for receiving said one or more attachment bolts;
wherein the central shaft holes of the main body weight and bottom lid plate have a greater diameter than the central bore hole of the inner adapter;
wherein the vertical attachment bolt holes on the main body weight and bottom lid plate are aligned to allow coupling of the main body weight and bottom lid via one or more attachment bolts;
wherein tightening the locking bolt while the shaft of the telescope mount is placed through the central bore hole of the inner adapter applies pressure to the shaft of the telescope mount, securing the invention to the shaft of the telescope mount.

2. The counterweight of claim 1 wherein said inner adapter and said main body weight both further comprise one or more horizontal attachment bolt holes;
wherein the horizontal attachment bolt holes of the inner adapter and the main body weight are aligned to allow coupling of the inner adapter main body weight and via one or more attachment bolts.

3. The counterweight of claim 1 wherein the inner adapter which further comprises one or more vertical attachment bolt holes;
wherein the vertical attachment bolt holes of the inner adapter are aligned with the vertical attachment bolt holes of the main body weight and bottom lid plate to allow coupling of the inner adapter, main body weight and bottom lid via one or more attachment bolts.

4. The counterweight of claim 2 wherein the inner adapter which further comprises one or more vertical attachment bolt holes;
wherein the vertical attachment bolt holes of the inner adapter are aligned with the vertical attachment bolt holes of the main body weight and bottom lid plate to allow coupling of the inner adapter, main body weight and bottom lid via one or more attachment bolts.

5. The counterweight of claim 1 wherein the inner adapter further comprises one or more threaded horizontal accessory holes.

6. The counterweight of claim 2 wherein the inner adapter further comprises one or more threaded horizontal accessory holes.

7. The counterweight of claim 3 wherein the inner adapter further comprises one or more threaded horizontal accessory holes.

8. The counterweight of claim 4 wherein the inner adapter further comprises one or more threaded horizontal accessory holes.

9. The counterweight of claim 1 further comprising one or more weight plates comprising a central shaft hole and one or more vertical attachment bolt holes;
wherein the vertical attachment bolt holes of the weight plates are aligned with the vertical attachment bolt holes of the main body weight and bottom lid plate to allow coupling of the inner adapter, main body weight and bottom lid via one or more attachment bolts;
wherein the central shaft hole of the weight plate is aligned with and has a larger diameter than the central bore hole of the inner adapter.

10. The counterweight of claim 2 further comprising one or more weight plates comprising a central shaft hole and one or more vertical attachment bolt holes;
wherein the vertical attachment bolt holes of the weight plates are aligned with the vertical attachment bolt holes of the main body weight and bottom lid plate to allow coupling of the inner adapter, main body weight and bottom lid via one or more attachment bolts;
wherein the central shaft hole of the weight plate is aligned with and has a larger diameter than the central bore hole of the inner adapter.

11. The counterweight of claim 2 further comprising one or more weight plates comprising a central shaft hole and one or more vertical attachment bolt holes
wherein the vertical attachment bolt holes of the weight plates are aligned with the vertical attachment bolt holes of the main body weight and bottom lid plate to allow coupling of the inner adapter, main body weight and bottom lid via one or more attachment bolts;
wherein the central shaft hole of the weight plate is aligned with and has a larger diameter than the central bore hole of the inner adapter.

12. The counterweight of claim 3 further comprising one or more weight plates comprising a central shaft hole and one or more vertical attachment bolt holes;
wherein the vertical attachment bolt holes of the weight plates are aligned with the vertical attachment bolt holes of the main body weight and bottom lid plate to allow coupling of the inner adapter, main body weight and bottom lid via one or more attachment bolts;
wherein the central shaft hole of the weight plate is aligned with and has a larger diameter than the central bore hole of the inner adapter.

13. The counterweight of claim 4 further comprising one or more weight plates comprising a central shaft hole and one or more vertical attachment bolt holes;
wherein the vertical attachment bolt holes of the weight plates are aligned with the vertical attachment bolt holes of the main body weight and bottom lid plate to allow coupling of the inner adapter, main body weight and bottom lid via one or more attachment bolts;
wherein the central shaft hole of the weight plate is aligned with and has a larger diameter than the central bore hole of the inner adapter.

14. The counterweight of claim 5 further comprising one or more weight plates comprising a central shaft hole and one or more vertical attachment bolt holes;
wherein the vertical attachment bolt holes of the weight plates are aligned with the vertical attachment bolt holes of the main body weight and bottom lid plate to allow coupling of the inner adapter, main body weight and bottom lid via one or more attachment bolts;
wherein the central shaft hole of the weight plate is aligned with and has a larger diameter than the central bore hole of the inner adapter.

15. The counterweight of claim 6 further comprising one or more weight plates comprising a central shaft hole and one or more vertical attachment bolt holes;
wherein the vertical attachment bolt holes of the weight plates are aligned with the vertical attachment bolt holes of the main body weight and bottom lid plate to allow coupling of the inner adapter, main body weight and bottom lid via one or more attachment bolts;
wherein the central shaft hole of the weight plate is aligned with and has a larger diameter than the central bore hole of the inner adapter.

16. The counterweight of claim 7 further comprising one or more weight plates comprising a central shaft hole and one or more vertical attachment bolt holes;
wherein the vertical attachment bolt holes of the weight plates are aligned with the vertical attachment bolt holes of the main body weight and bottom lid plate to allow coupling of the inner adapter, main body weight and bottom lid via one or more attachment bolts;
wherein the central shaft hole of the weight plate is aligned with and has a larger diameter than the central bore hole of the inner adapter.

17. The counterweight of claim 8 further comprising one or more weight plates comprising a central shaft hole and one or more vertical attachment bolt holes;
wherein the vertical attachment bolt holes of the weight plates are aligned with the vertical attachment bolt holes of the main body weight and bottom lid plate to allow coupling of the inner adapter, main body weight and bottom lid via one or more attachment bolts;
wherein the central shaft hole of the weight plate is aligned with and has a larger diameter than the central bore hole of the inner adapter.

18. The counterweight of claim 1 wherein the bottom lid plate further comprises a slot shaped to allow insertion of the inner adapter.

19. The counterweight of claim 4 wherein the bottom lid plate further comprises a slot shaped to allow insertion of the inner adapter.

20. The counterweight of claim 1 wherein the bottom lid plate further comprises a slot shaped to allow insertion of the inner adapter.

21. The counterweight of claim 8 wherein the bottom lid plate further comprises a slot shaped to allow insertion of the inner adapter.

22. The counterweight of claim 17 wherein the bottom lid plate further comprises a slot shaped to allow insertion of the inner adapter.
